(19) United States
(12) Patent Application Publication
(10) Pub. No.: US 2006/0052125 A1
(43) Pub. Date: Mar. 9, 2006

(54) Network and terminal for forming an adhoc network by responsive to an inquiry forwarded by a slave terminal, setting up by the master unit a connection with the terminal to be incorporated into the network

(75) Inventors: Thomas Falck, Aachen (DE); Javier Espina Perez, Aachen (DE); Henning Maass, Aachen (DE); Klaus Weidenhaupt, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., THE NETHERLANDS (NL)

(21) Appl. No.: 10/541,401

(22) PCT Filed: Dec. 17, 2003
(86) PCT No.: PCT/IB03/06309

§ 371 Date: Jul. 1, 2005

(30) Foreign Application Priority Data
Jan. 10, 2003 (EP) 03100038.3

(51) Int. Cl. H04B 7/00

(52) U.S. Cl. 455/517

(57) ABSTRACT

The invention relates to a network having at least one slave terminal (7-10) and a master terminal (6) that is connected thereto that is provided for instructing at least one slave terminal (7) to check for inquiries from at least one other terminal (11) to be incorporated in the network. The instructed slave terminal (7) following detection of an as yet non-incorporated terminal (11) forwards the received inquiry to the master terminal. Upon receipt of the inquiry from the slave terminal, the master terminal sets up a connection with the as yet non-incorporated terminal. In an embodiment, the master terminal (6) sets up the connection by emitting an inquiry and paging the new slave terminal (11).

The invention relates to a network having at least one slave terminal and a master terminal connected thereto. Such networks may, for example, comprise terminals that operate according to the Bluetooth Standard.

The Bluetooth Standard was originally developed in order to make possible a wireless communication of the widest variety of terminals over short distances. It was only after a time that the requirement for an interconnection of Bluetooth terminals, the creation of a so-called adhoc network arose. In this connection, however, the problem arises of how a Bluetooth network comprising a plurality of subscribers is formed rapidly and automatically since the Bluetooth Specification made no provisions therefor. The document “Bluetooth SIG, PAN Working Group, Personal Area Networking Profile, Version 1.0, Jul. 23, 2002, pages 10 to 12” describes, for example, how a network is to be formed under the Bluetooth Standard. This specifies that a network formation takes place only manually, i.e. no proposals are made about the form in which a terminal can automatically be incorporated in a network and can make connections, for example, to even two connected terminals.

It is an object of the invention to provide a network that automatically makes possible incorporation of a terminal.

The object is achieved by a network of the type mentioned at the outset by the following measures:

The network has at least one slave terminal and a master terminal connected thereto that is provided to instruct at least one slave terminal to check for inquiry scans for at least another terminal to be incorporated in the network,

wherein the instructed slave terminal, once it has detected a terminal that has not yet been incorporated is provided to forward the inquiry scan to the master terminal and the master terminal once it has received the inquiry scan from the slave terminal is provided to establish a connection with the terminal that has not yet been incorporated.

According to the invention, it is not the job of the master terminal, but of the slave terminal so instructed, to establish if a terminal that has not been incorporated in the network is emitting inquiry scans. In this way, the master terminal can largely take care of communications on the network. Once the slave terminal has received an inquiry scan from a terminal that has not yet been incorporated, this inquiry scan that has been received is forwarded to the master terminal, which then as specified in claim 3, begins to establish a connection with this terminal under certain conditions. One condition could be, by way of example, that a terminal has not previously been connected to the network. These conditions could be checked by means of a special list (blacklist) managed by the master terminal, as specified in claim 4. The master terminal begins to establish the connection by emitting an inquiry scan.

Furthermore, as claimed in claim 5 the invention provides that a slave terminal only performs checks on inquiry scans if the master terminal is not emitting any inquiry scans. This prevents a member of the network discovering another member of the network again.

The network according to the invention can be formed with terminals that operate according to the Bluetooth Standard. The construction of the software components provided therefor is presented in claim 6.

In order not to disturb the communication in the network unnecessarily, the master terminal is provided to instruct only a single slave terminal, not involved in the communication, to check for inquiry scans from a terminal.

A speeding up of the network formation can be achieved by using an identifier in at least one message sent between the terminals, as specified in claim 8. The identifier provides information on whether or not a terminal is already incorporated in a network.

The invention also relates to a terminal which is provided for incorporation as a slave or master terminal in a network.

These and other aspects of the invention are apparent from and will be elucidated with reference to the embodiments described hereinafter.

In the drawings:

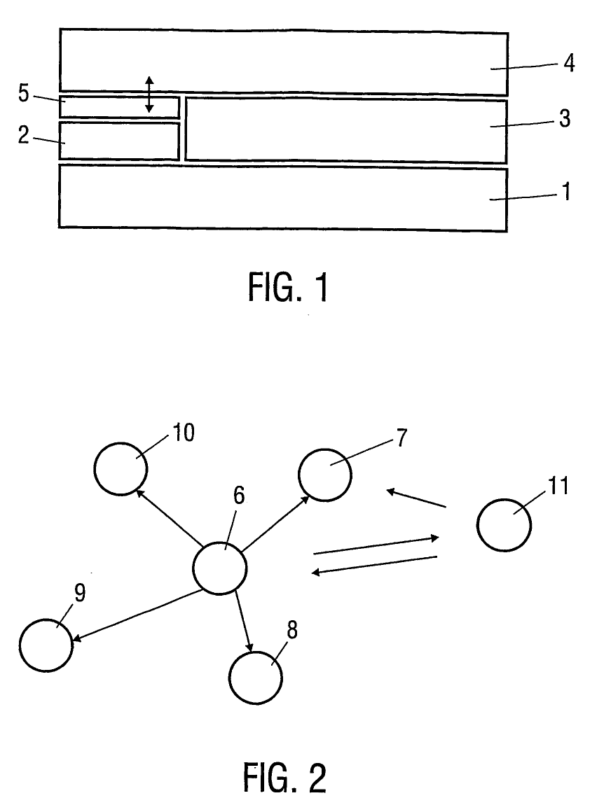

FIG. 1 shows an extremely simplified layer model of the software components contained in a terminal;

FIG. 2 shows a network having various incorporated terminals and a further terminal to be incorporated, and

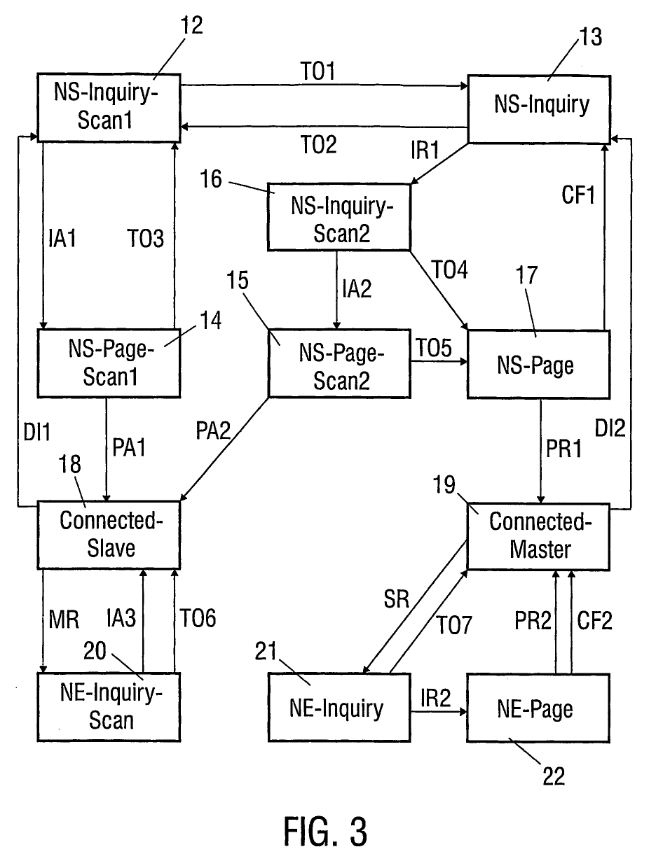

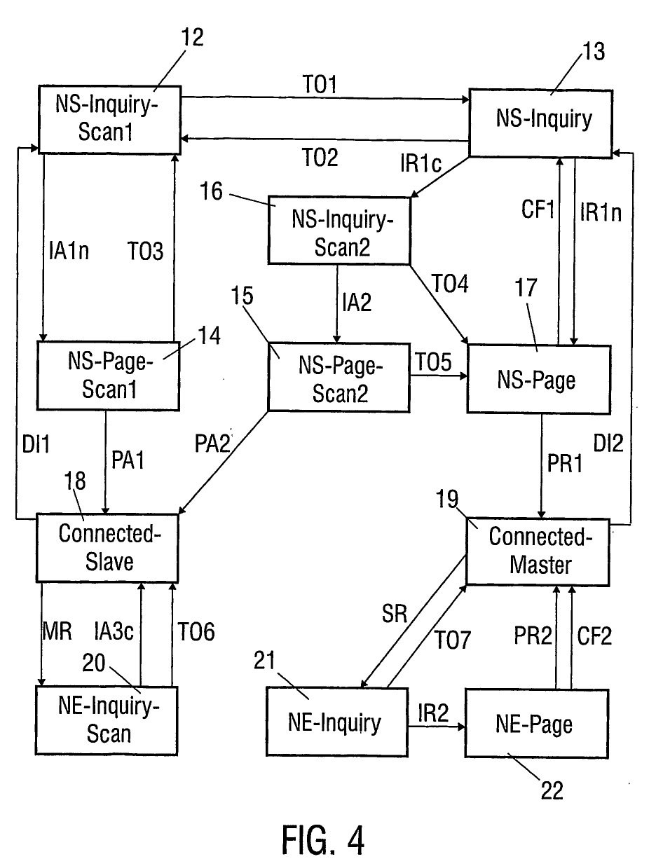

FIGS. 3 and 4 show state diagrams for explaining the software components, according to the invention, of a terminal.

Bluetooth is a communications standard for wireless radio communication that is intended to make possible data exchange between all the conceivable terminal types.

Everything, whether a notebook, organizer, mobile telephone or peripheral appliances of computers, is intended to acquire the capability through Bluetooth to communicate mutually.

The terminals in a Bluetooth network operate on 79 channels, each having a bandwidth of 1 MHz in the 2.45 GHz frequency range. It is not one and the same channel that is constantly used for the communication, but the frequency is altered (frequency hopping) 1,600 times per second in order to eliminate interference with other appliances. This is necessary since the frequency band used is not freely available. The useful data are transported in a packet-oriented way and, in order to meet application requirements, various packet types are defined. They differ according to synchronous and asynchronous operation and are identified by an entry in the header.

Essential properties of a Bluetooth appliance are, on the one hand, a separate clock rate that sets the clock rate in the case of frequency changes and also an unambiguous Bluetooth terminal address (Bluetooth device address). This then also produces the identity of the terminal, which stipulates the various frequencies in the hopping sequence.

During the connection of two Bluetooth terminals, one takes on the role of the master terminal and the other the role of the slave terminal. In this connection, it is to be noted that there is not such a thing as predetermined master or slave terminals and the role distribution takes place dynamically when setting up a call. The master terminal compulsorily determines the hopping sequence, that is to say the “jumps” between the frequencies, for the slave terminal and distributes the transmission rights.

When setting up a call, two phases are traversed. The first phase is denoted as the inquiry phase and is used when terminals not yet discovered about which no information items are yet available are to be sought. As long as there is no connection, a terminal constantly alternates between the states of inquiry (request) and inquiry-scan (search for a request). In the inquiry state, the terminal jumps between 32 frequencies and sends out its request. In the inquiry-scan state, the appliance likewise jumps between 32 frequencies and searches for an inquiry message. If a terminal in the inquiry-scan state receives such a request, it responds by transmitting its address and its clock rate, and a communication can start.

The second phase of setting up a call is denoted as the paging phase. In this phase, one terminal converts to the paging (call) state and the other terminal to the page-scan (search for a call) state. In this connection, the role distribution is defined in such a way that the requesting terminal becomes the master terminal and the other terminal becomes a slave terminal. A precondition is that the Bluetooth terminal address of the slave terminal is known to the master terminal. The paging phase can be accelerated if, in addition to the address, the clock rate of the slave terminal is also available to the master terminal. The master terminal transmits to the slave terminal its own clock rate and hopping sequence and instructs it to adopt it. The slave terminal then synchronizes with the master terminal and can consequently communicate with it.

Transmitted between the individual terminals are data packets that contain, in addition to the useful data, also additional information items, such as, for example, transmitter and receiver address, transmitting options, synchronization information items and optionally security information items and additional redundancies. Such a packet comprises a 72-bit access code, a 54-bit header, and also a variable useful-data field having a length of 0 to 2745 bits. For the inquiry phase, for example, an ID packet is used that contains the address of the terminal. A further packet is the FHS (frequency hopping synchronization) with which, inter alia, clock rate information items, the terminal address, the phase of the hopping sequence, the designation of the “class of service” (which type of appliance is involved in the piconet) are transmitted when setting up a connection.

Bluetooth networks can be implemented in a point-to-point, piconet and scatternet topology. Said network topologies open up a multiplicity of conceivable application possibilities. A piconet comprises a master terminal and up to seven active slave terminals. A master may, in principle, control more than seven slave terminals by putting a few slave terminals in a type of sleep mode. However, this may appreciably slow down data exchange, especially if an active slave terminal wishes to transmit data to another slave terminal in a sleep mode. In this connection, the communication basically proceeds exclusively via the master terminal, which distributes transmitting rights and which specifies the frequencies to be used. The master terminal alternately distributes transmitting rights to the individual slave terminals.

Owing to the application of frequency hopping, it is possible for a plurality of piconets to coexist alongside one another. In this connection, a terminal may even be a member in a plurality of piconets. For this purpose, the terminal simply stores the hopping sequence of all the master terminals in whose network it is a member and can thus tune to the frequency of each network. Such a terminal is denoted as a bridge terminal (bridge node) since it is, as it were, a bridge between the piconets. A plurality of piconets connected in this way form a scatternet.

The Bluetooth Standard was originally developed in order to make possible a wireless communication of the widest variety of terminals over short distances. It was only after a time that the requirement for an interconnection of Bluetooth terminals, the creation of a so-called adhoc network arose. For example, a plurality of subscribers of a seminar having Bluetooth terminals are situated in a room and these individuals would like to exchange their data with one another. Ideally, each subscriber would execute a command of the type “set up connection to adhoc network”. After a short time a message “connection to adhoc network exists” would be received and they would then be able to exchange data with any other subscribers. In this connection, however, the problem arises of how a Bluetooth network comprising a plurality of subscribers is formed rapidly and automatically since the Bluetooth Specification makes no provisions therefor.

A terminal contains, according to the invention, a software component that is designated as “dynamic personal area network manager” (referred to below as DPM software) and that interacts with the actual Bluetooth software and the respective application software and is provided for forming and for controlling an adhoc network. A considerably simplified layer model of the software component is shown in FIG. 1. Disposed above layer 1, which represents the Bluetooth software (first software component), is the layer containing the DPM software 2 (second software component) and a software 3 provided for the Internet protocol. In the uppermost layer 4 is the application software, which starts, controls and terminates the DPM software via a software interface 5 (designated below as DPM API software).

During the formation of the adhoc network, a network formation procedure described below is executed by the respective DPM software in the terminal concerned. The first step in an automatic adhoc network formation according to the invention is an automatic detection of terminals in their respective environment. Before the start of a network formation, the terminals have to collect information items relating to their environment independently of one another. Furthermore, each terminal can independently form an adhoc network by executing the inquiry and inquiry-scan states described above in a non-existent network. The switching time between the two states must in that case be chosen randomly.

Every terminal not having a connection searches for other terminals in its environment (inquiry phase). If another terminal has been found, the inquiry phase is stopped and a connection is formed with the detected terminal (via the paging phase). Consequently, a new piconet can be created spontaneously. If a third terminal detects a terminal of the piconet just formed, the procedure described below is used for incorporating the third terminal.

According to the invention, a master terminal selects in each case an assigned slave terminal (in the following referred to as a listening slave terminal) in a certain sequence, so as to check if a terminal that is not incorporated is performing inquiry scans. An inquiring terminal, which wishes to be incorporated in the network, switches between the inquiry and inquiry scan states as well. The master terminal itself neither switches to the inquiry state nor to the inquiry scan state in this phase. The listening slave terminal regularly converts to the inquiry scan state, but never to the inquiry state. In this way, the effort of the terminal on detection of a terminal that has previously not been incorporated is kept low. Since only one slave terminal is a listening terminal in each case, interference with the communication within the network is minimized.

The incorporation of further slave terminals can be explained by the following steps and by means of FIG. 2. FIG. 2 shows a master terminal 6 and four slave terminals 7 to 10 connected to the master terminal 6. All the terminals 6 to 10 are in the connected state. Only on the instruction of the master terminal 6 does one of the slave terminals 7 to 10 convert to the inquiry scan state. The terminal 11 approaches the piconet (comprising the terminals 6 to 10) and should be incorporated in the piconet. In a first step, the master terminal 6 instructs precisely one of its slave terminals (listening slave terminal) to convert to the inquiry scan state, i.e. to check if a terminal is performing inquiry scans. In FIG. 2, this is by way of example the slave terminal 7. The terminal 11, which has not so far been incorporated in the piconet, approaches the latter and converts between the inquiry and inquiry scan states. The terminal 11 checks if another terminal is emitting inquiry scans, and emits enquiry scans.

Once the listening slave terminal 7 in the inquiry scan state has received an inquiry scan from terminal 11 and responded to it, the inquiry scan state is terminated and the master terminal 6 sends a message concerning receipt of an inquiry scan from the terminal 11. Following receipt of a response from the slave terminal 7, the terminal 11 converts to the inquiry-scan state in anticipation of receiving an inquiry scan from the master terminal. The master terminal 6 following receipt of the notification from the slave terminal 7, that a terminal that is not yet incorporated is performing inquiry scans, converts to the inquiry state and then emits its own inquiry scan, which the terminal 11 which has not yet been incorporated receives in the inquiry scan state. The terminal 11 replies with a packet containing its address (FHS packet) and converts to the page-scan state in order to connect to the piconet. The master terminal 6 now has all the necessary information to incorporate the terminal 11 to the network. The master terminal 6 then converts to the page state and pages the new terminal 11 which accepts and thus becomes a new member of the existing piconet. Then the master terminal 6 instructs the next slave terminal (e.g. slave terminal 8) to convert to the inquiry scan state and to listen for inquiry scans.

The master terminal orders the slave terminals in a particular sequence to listen or receive inquiry scans. For example, said certain sequence may appear such that all slave terminals convert one after the other after a timeout that is the same in each case to the inquiry scan mode.

The function of the DPM software, which controls the process described above, can be explained be reference to the state diagram shown in FIG. 3. The DPM software has a total of eleven states that are indicated by the rectangles 12 to 22 in FIG. 3. The states indicated by the rectangles 12 to 17 relate to the situation where a terminal not yet connected to a network sets up a connection. In the NS inquiry-scan1 (rectangle 12) NS inquiry-scan2 (rectangle 16) and NS inquiry (rectangle 13) states, the terminal has not formed a connection, in the NS page-scan1 (rectangle 14), NS page-scan2 (rectangle 15) and NS page (rectangle 17) states, the terminal is in the process of setting up a connection. In the connected-slave state (rectangle 18) and connected-master state (rectangle 19), the terminal has set up a connection and is a member of a piconet. The NE inquiry-scan (rectangle 20), NE inquiry (rectangle 21) and NE page (rectangle 22) states relate to the case where an existing network is extended.

In the unconnected state, the terminal alternates periodically between the NS inquiry-scan1 state (rectangle 12) and NS inquiry state (rectangle 13) as indicated by arrows TO1 and TO2, after the expiry of a certain time (timeout).

If the terminal in the NS inquiry-scan1 state (rectangle 12) has responded to another terminal in response, the DPM software converts to the NS page-scan1 state (rectangle 14) (via the arrow IA1), in which the terminal awaits a call request (page) from the other terminal. If the terminal responds to a call request, the connection is set up and the DPM software converts to the connected-slave state (rectangle 18) (via arrow PA1). The terminal is then a slave terminal in the network. Otherwise, after the expiry of a specified time (timeout) without call request, the DPM software reverts to the NS inquiry-scan1 state (rectangle 12) (arrow TO3).

If the terminal in the NS inquiry state (rectangle 13) has received a response to its inquiry from another terminal, the DPM software converts to the NS inquiry-scan2 state (rectangle 16) (arrow IR1), in which it waits for receipt of an inquiry. If no network has previously been formed, and thus just two terminals are communicating with each other without a network yet, this terminal in the NS inquiry-scan2 state can receive an inquiry and following a timeout change to the NS page state (rectangle 17) (arrow TO4). In this NS page state of the DPM software, the other terminal is paged which sent a response to the inquiry in the NS inquiry state. It must be ensured that the timeout between the NS inquiry-scan2 and NS page states is selected to be less than the timeout between the NS page-scan1 and NS inquiry-scan1 states. As soon as the other terminal responds to a page, the connection is set up and the DPM software converts to the connected-master state (rectangle 19) (arrow PR1). The terminal is then the master terminal of the newly created piconet. In the other case—failure to establish a connection—the DPM software reverts to the NS inquiry state (rectangle 13) (arrow CF1)

If a piconet exists, the master terminal orders one of its slave terminals to listen for inquiries from other non-incorporated terminals. In this case, the DPM software of the slave terminal determined by the master terminal converts from the connected-slave state (rectangle 18) to the NE inquiry-scan state (rectangle 20) (arrow MR). After a timeout, the DPM software of the terminal reverts to the connected-slave state (rectangle 18) (arrow TO6).

If a slave terminal in the NE inquiry-scan state (rectangle 20) receives an inquiry from a terminal that is not incorporated in the network, then it replies to this, ceases listening for inquiries and reverts to the connected-slave state (rectangle 18) (arrow IA3). It also informs the master terminal that a new terminal has been discovered which is making inquiries. The DPM software of the master terminal then converts from the connected-master state (rectangle 19) to the NE inquiry state (rectangle 21) (arrow SR). The master terminal begins an inquiry and receives a response (FHS packet) from the interconnecting terminal. For the ensuing establishment of a connection, the DPM software of the master terminal converts to the NE page state (rectangle 22) (arrow IR2). If the master terminal has not received a response after a timeout, its DPM software reverts to the connected-master state (rectangle 19) (arrow TO7).

In the NE page state (rectangle 22), the terminal to be incorporated is paged that sent a response to the inquiry in the NS inquiry state. As soon as the terminal responds to the page, the connection is established and the DPM software of the master terminal converts to the connected-master state (rectangle 19) (arrow PR2). In the other case—connection failure—the DPM software reverts to the connected-master state (rectangle 19) (arrow CF2) and orders the next slave terminal to listen for inquiries, i.e. to check if a terminal that is not incorporated is performing scans.

In the event that a network exists and a terminal wishes to incorporate as a slave terminal, the DPM software of the terminal to be incorporated, following receipt of a response from the listening slave terminal to its inquiry, converts from the NS inquiry state (rectangle 13) to the NS inquiry-scan2 state (rectangle 16) (arrow IR1) and waits for an inquiry from the master terminal. Following receipt of an inquiry from the master terminal, it sends the latter a response (FHS packet). The DPM software of the terminal converts to the NS page-scan2 state (rectangle 15) (arrow IA2) and then waits for a page from the master terminal. Following receipt of the page and the response from the terminal, the connection is established and the DPM converts to the connected-slave state (rectangle 18) (arrow PA2). The terminal is then incorporated as a slave terminal on the network. Otherwise after a timeout without a page the DPM software reverts to the NS page state (rectangle 17) (arrow TO5) and tries to start a page itself. In the event of failure to set up a connection, the DPM software reverts to the NS inquiry (rectangle 13) state (arrow CF1).

It is worth mentioning that a situation can never arise in which a terminal of the existing network is in the inquiry state and another terminal of the existing network is simultaneously in the inquiry-scan state. Because the slave terminal of an existing network never converts to the inquiry state and the master terminal never converts to the inquiry-scan state. The remaining case in which the master terminal is in the Inquiry state while simultaneously a slave terminal is in the inquiry-scan state, is excluded, since the master terminal converts to the inquiry state only if the very slave terminal that is listening ends the inquiry-scan state and has informed the master terminal that a new terminal is making inquiries. This ensures that a terminal that already belongs to the network is not discovered again.

If the DPM software receives the instruction from the application software to clear the connection, the DPM software orders the connection to be cleared and the DPM software converts to the NS inquiry-scan1 state (arrow DI1) or the NS inquiry state (arrow DI2).

To optimize the network formation further, applications can place the addresses of undesired terminals on a so-called special list (blacklist) by means of the DPM-API software. Whenever a new terminal is discovered, the master terminal first checks whether it is contained in the special list. In this case, the terminal is ignored, i.e. no attempt is made to set up a connection to said terminal. Otherwise, a connection is set up as described above.

The special list cites, for example, those terminals that were incorporated in the network a certain time ago and are no longer of interest. Furthermore, those terminals can be stored in said special list that do not offer certain services. For example, if a printer is sought for the network, all the terminals not having this printer service are stored in said special list.

The procedure according to the invention is suited in particular to networks in which a high service level (i.e. the highest possible available bandwidth, the fewest possible errors or even losses of existing connections) is desired from the network. The procedure described for expanding the network disturbs the communication of the devices that already belong to the network altogether as little as possible. The main cause of errors here is, in particular, the execution of inquiries, since while an inquiry is being executed the available bandwidth of the existing connections is considerably reduced and in some cases a complete loss of communication even results. In the process according to the invention, it is only the master terminal that performs inquiries and only when it has been ensured that a new terminal is in the vicinity. In order to expand an existing network by one terminal, the master terminal must therefore perform just one single inquiry. Since on the other hand just to find out the address of the new terminal at least one inquiry is essential, the procedure according to the invention is characterized by the minimum possible number of inquiries.

As already mentioned above, a packet contains a field which is referred to as Class of Service and which is used for the response to an inquiry. The current Bluetooth Standard has reserved a further few bits in this field which have so far not been occupied. A reserved bit in this field can be used to identify if a terminal is connected to a network. This allows the network to be formed more quickly.

This reserved bit will in the following be referred to as the connection bit. If a terminal is already incorporated (connected) to a network this connection bit is set at logic “1”, otherwise it is set at logic “0”.

The state diagram for the DPM software when this connection bit is used is shown in FIG. 4. Compared with FIG. 3, a further state change has been added. The arrow IR1n indicates the change of state from the NS inquiry (rectangle 13) state to the NS page state (rectangle 17). Furthermore, the connection bit is used for the state changes from the NS inquiry-scan1 (rectangle 12) state to the NS page-scan1 state (rectangle 14) (arrow IA1n instead of IA1 in FIG. 3), from the NS inquiry state (rectangle 13) to the NS inquiry-scan2 state (rectangle 16) (arrow IR1c instead of IR1 in FIG. 3) and from the NE inquiry-scan (rectangle 20) state to the connected-slave state (rectangle 18) (arrow IA3c instead of IA3 in FIG. 3). There are no other differences between FIGS. 3 and 4.

An as yet unconnected terminal, which is in the NS inquiry-scan1 state (rectangle 12), responds to an inquiry with a connection bit set at logic “0” and converts to the NS page-scan1 state (rectangle 14) (arrow IA1n).

A slave terminal that is already connected, which is in the NE inquiry-scan state (rectangle 20), responds on the other hand to an inquiry with a connection bit set at logic “1” and converts to the connected-slave state (rectangle 18) (arrow IA3c).

The connection bit is evaluated of an as yet unconnected terminal, which is in the NS inquiry state (rectangle 13). If a response is received to its inquiry, it can use the connection bit to decide if the other terminal is likewise still unconnected (connection bit is logic “0”) or if it already belongs to a network as a slave terminal (connection bit is logic In the first case (connection bit is logic “0”), a new network is formed, in which the inquiring terminal takes the role of master terminal and the other the role of the slave terminal. For this to happen, the inquiring terminal initially converts to the NS page state (rectangle 17) (arrow IR1n) and then pages the other terminal causing a connection to be set up.

In the other case (connection bit is logic “1”), the inquiring terminal joins the existing network as a further slave terminal. For this to happen, the inquiring terminal initially converts to the NS inquiry-scan2 state (rectangle 16) (arrow IR1c) and waits for the inquiry from the master terminal of the existing network.

This measure allows the initial network formation to be performed more quickly, since it is not necessary to wait for a timeout before ascertaining that both terminals are still unconnected. In this situation, the connection bit can be used to convert directly from the NS inquiry state (rectangle 13) to the NS page state (rectangle 17) (arrow IR1n) instead of—as shown in FIG. 3—after a fruitless wait for an inquiry changing from the NS inquiry-scan 2 state (rectangle 16) to the NS page state (rectangle 17) (arrow TO4).

1. A network having at least one slave terminal and a master terminal connected thereto that is provided for instructing at least one slave terminal to check for inquiries for at least another terminal to be incorporated in the network, wherein the instructed slave terminal, once it has detected a terminal that has not yet been incorporated is provided to forward the received search request to the master terminal and the master terminal, once it has received the search request from the slave terminal is provided to set up a connection with the terminal that has not yet been incorporated.

2. A network as claimed in claim 1, characterized in that, after receiving an inquiry from a terminal not previously incorporated, the master terminal is provided to send an inquiry.

3. A network as claimed in claim 1, characterized in that, after receiving an inquiry from a terminal not previously incorporated, the master terminal is provided to set up a connection with this terminal under certain conditions.

4. A network as claimed in claim 3, characterized in that a slave terminal incorporated in the network is not provided for the change into the state in which it transmits a response to an inquiry from another terminal while the master terminal is simultaneously carrying out inquiries.

5. A network as claimed in claim 1, characterized in that a slave terminal incorporated in the network is not provided for the change into the state in which it transmits a response to an inquiry from another terminal.

6. A network as claimed in claim 1, characterized in that a terminal has a first software component operating according to the Bluetooth Standard and a second software component for controlling the first software component, which second software component is provided for converting instructions of a third application-oriented software, and in that the second software component is provided for incorporating a terminal.

7. A network as claimed in claim 1, characterized in that the master terminal is provided to issue a request to only a single slave terminal not involved in the communication, with the checking of inquiries for at least another terminal to be incorporated in the network.

8. A network as claimed in claim 1, which contains at least one message transmitted between the terminals containing information on whether a terminal is incorporated in a network.

9. A terminal that is provided for incorporation as a slave or master terminal in a network, wherein the terminal acting as a master terminal is provided to instruct at least one slave terminal to check inquiries for at least another terminal to be incorporated in the network, wherein the terminal acting as a slave terminal is provided following detection of an as yet non-incorporated terminal to forward the received inquiry to the master terminal and the terminal acting as a master terminal is provided following receipt of the inquiry from the slave terminal to set up the connection with the as yet non-incorporated terminal.
